(19) United States
(12) Patent Application Publication
(10) Pub. No.: US 2016/0326670 A1
(43) Pub. Date: Nov. 10, 2016

(54) ANTIBACTERIAL FIBER MATERIAL, ANTIBACTERIAL FIBERS, MASTER BATCH FOR MANUFACTURING ANTIBACTERIAL FIBERS, AND METHOD FOR MANUFACTURING ANTIBACTERIAL FIBERS

(71) Applicant: NANO, FUTURE AND LIFE, INC., Chungcheonngbuk-do (KR)

(72) Inventors: Jong Won KANG, Seongnam-si (KR); Jeong Heui KIM, Cheonan-si (KR); Byung Kyu PARK, Giheung-gu (KR)

(21) Appl. No.: 15/110,434

(22) PCT Filed: Jan. 10, 2014
(86) PCT No.: PCT/KR2014/000310

§ 371 Date: Jul. 8, 2016

(51) Int. Cl. D01F 1/10; D01D 5/08; D01D 1/06; D01F 6/06; C08J 3/22

(52) U.S. Cl. CPC D01F 1/103; D01F 6/06; C08J 3/226; D01D 1/065; D01D 5/08; C08J 2323/12

(57) ABSTRACT

Disclosed are antibacterial fibers, a master batch for manufacturing antibacterial fibers, and a method for manufacturing antibacterial fibers. The antibacterial fibers can exhibit excellent antibacterial activity by using, as an antibacterial agent, zinc oxide nanoparticles having a high specific surface area, a low melting temperature, and a stable crystal structure.

### TECHNICAL FIELD

The inventive concept relates to an antibacterial fiber material, antibacterial fibers, a master batch for manufacturing antibacterial fibers, and a method for manufacturing antibacterial fibers.

### BACKGROUND ART

Efforts have been made to effectively block the spread of germs and fungus that threaten human health as well as virus and bacteria that are harmful to the human body according to changes in the environment.

A conventional organic antibacterial agent has been commonly used to incorporate an antibacterial function into a fiber product formed of plastic, which is a polymer compound often used in daily life. However, there is some refrain in use of the conventional organic antibacterial agent due to an increase in tolerance and its toxicity to the human body by its nature.

As an alternative of the organic antibacterial agent, the appearance of an inorganic-based antibacterial agent and the appearance of nanotechnology have increased the chance to practice new technologies.

### DETAILED DESCRIPTION OF THE INVENTIVE CONCEPT

### Technical Problem

One aspect of the present disclosure is to provide an antibacterial fiber material having an excellent antibacterial property.

Another aspect of the present disclosure is to provide antibacterial fibers including the antibacterial fiber material.

Another aspect of the present disclosure is to provide a master batch used for manufacturing the antibacterial fibers.

Another aspect of the present disclosure is to provide a method for manufacturing the antimicrobial fibers.

### Technical Solution

According to an aspect of the inventive concept, there is provided an antibacterial fiber material including a polymer resin; and a zinc oxide in a form of a powder comprising secondary particles that includes agglomerated primary particles, wherein an average particle diameter of the primary particles of the zinc oxide is in a range of about 1 nm to about 50 nm and an average particle diameter of the secondary particles is in a range of about 0.1 μm to about 10 μm.

A specific surface area of the zinc oxide may be about 40 m²/g or greater.

A melting temperature of the zinc oxide may be about 350° C. or higher.

The melting temperature of the zinc oxide may be in a range of about 350° C. to about 450° C.

The polymer resin may include at least one selected from acrylonitrile-butadiene-styrene (ABS), polypropylene (PP), polyethylene (PE), polystyrene (PS), polyvinyl acetate (PVAc), polyacrylate, polyethylene terephthalate (PET), polyvinyl chloride (PVC), polymethyl methacrylate (PMMA), ethylene-vinyl acetate copolymer (EVA), polycarbonate (PC), polyamide, and a silicone-based resin.

An amount of the zinc oxide may be in a range of about 0.01 wt % to about 10 wt %, and an amount of the polymer resin may be in a range of about 90 wt % to about 99.99 wt %, based on the total amount of the zinc oxide and the polymer resin.

The antibacterial fiber material may further include at least one additive selected from sunscreens, antistatic agents, softeners, sorbents, absorbents, deodorants, water repellents, antifouling agents, and flame retardants. The additive may be included at an amount in a range of about 0.01 part by weight to about 5 parts by weight based on 100 parts by weight of the antibacterial fiber material.

According to another aspect of the inventive concept, there is provided antibacterial fibers including the antibacterial fiber material.

According to another aspect of the inventive concept, there is provided a master batch for manufacturing antibacterial fibers including a polymer resin; and a zinc oxide as a powder comprising secondary particles that are formed of agglomerated primary particles, wherein an average particle diameter of the primary particles of the zinc oxide is in a range of about 1 nm to about 50 nm and an average particle diameter of the secondary particles is in a range of about 0.1 μm to about 10 μm.

An amount of the zinc oxide may be in a range of about 1 wt % to about 50 wt %, and an amount of the polymer resin is in a range of about 50 wt % to about 99 wt %, based on the total amount of the zinc oxide and the polymer resin.

The mater batch may further include at least one additive selected from dispersants, softeners, absorbents, deodorants, and water repellents. The additive may be incuded at an amount in a range of about 0.1 part by weight to about 30 parts by weight based on 100 parts by weight of the master batch.

According to another aspect of the inventive concept, there is provided a method for manufacturing antibacterial fibers including preparing a mixture that comprises the master batch and a polymer base resin; and discharging the mixture.

The polymer base resin may be of a same type as a polymer resin used in the master batch.

The master batch and the polymer base resin may be mixed at an appropriate ratio according to a desired amount of zinc oxide in the antibacterial fibers.

### Advantageous Effects

As described herein, according to an aspect of the inventive concept, an antibacterial fiber material that has a high specific surface area and a low melting temperature includes zinc oxide nanoparticles having a stable crystal structure as an antibacterial agent, and thus antibacterial fibers that exhibit an excellent antibacterial activity may be provided.

### DESCRIPTION OF THE DRAWINGS

FIG. 1 is an image that shows the results of antibacterial degree measurement of Staphylococcus aureus ATCC 6538 of antibacterial fibers according to Example 1;

FIG. 2 is an image that shows the results of antibacterial degree measurement of Escherichia coli ATCC 25922 of antibacterial fibers according to Example 1; and

FIG. 3 is an image that shows the results of antibacterial degree measurement of Pseudomonas aeruginosa ATCC 27853 of antibacterial fibers according to Example 1.

### BEST MODE

Hereinafter, the present disclosure will be described in detail.

According to an aspect of the present disclosure, an antibacterial fiber material includes a polymer resin; and a zinc oxide in a form of a powder including secondary particles that includes agglomerated primary particles, wherein an average particle diameter of the primary particles of the zinc oxide is in a range of about 1 nm to about 50 nm and an average particle diameter of the secondary particles is in a range of about 0.1 μm to about 10 μm.

The polymer resin that constitutes the antibacterial fiber material is a synthetic resin, which may form a fiber phase, and thus may be any synthetic resin that may be used as fibers, but it is not limited thereto. For example, the polymer resin may include at least one selected from acrylonitrile-butadiene-styrene (ABS), polypropylene (PP), polyethylene (PE), polystyrene (PS), polyvinyl acetate (PVAc), polyacrylate, polyethylene terephthalate (PET), polyvinyl chloride (PVC), polymethyl methacrylate (PMMA), ethylene-vinyl acetate copolymer (EVA), polycarbonate (PC), polyamide, and a silicone-based resin.

The polymer resin may include matting agents, modifying agents, charging agents, and pigments within a range that does not decrease the antibacterial activity.

The antibacterial fiber material includes a zinc oxide, which is an inorganic antibacterial agent, as an antibacterial agent. A zinc oxide has an excellent resistance to toxic or germs as it acts on and paralyzes particular enzymes that function oxygen and digestion metabolisms in unicellular animals such as bacteria, viruses, or mycetes, and thus the zinc oxide has been known for its catalytic function to suffocate or starve germs.

Until recently, a method of dispersing silver nanoparticles, as an inorganic-based antibacterial agent, in a plastic-fiber product has been continuously tried, but application of the silver nanoparticles to an actual product has been limited due to discoloration of polymer fibers in the final product as well as its self-hazardous property and lack of economical efficiency because of high cost. On the other hand, the zinc oxide is a material that has been widely used as sunscreens for its excellent UV blocking effects, which also has been widely applied to cosmetics and vitamin products due to its significantly low riskiness with respect to environments and excellent compatibility in the human body, unlike silver. Therefore, the zinc oxide may be used as an antibacterial agent as an alternative of silver nanoparticles.

A way that the zinc oxide exhibits the antibacterial effect is performed by using a mechanism that inhibits metabolisms in virus or bacteria to deactivate and remove them as described above, not by causing a sterilizing effect due to photocatalyst activity. The zinc oxide in nanosize has an increased specific surface area, which generates a surface effect that a bulk material cannot have, and, when the antibacterial fibers contact moisture in the air, particularly, a zinc metal component of the zinc oxide present on surfaces of the fibers elutes as it is ionized, and thus may act as an antibacterial agent to harmful germs such as bacteria.

The zinc oxide is formed of secondary particles that are formed of agglomerated primary particles for an effective surface effect. Here, sizes of the primary particles and the secondary particles may be controlled to increase their dispersability in a polymer resin and ease of handling, and thus the nanosized zinc oxide may be effectively distributed in the antibacterial fibers. In this regard, when the surface effect is effectively manifested, the antibacterial activity may be maximized.

An average particle diameter of the first particles may be, for example, in a range of about 1 nm to about 50 nm, or, in particular, may be in a range of about 1 nm to about 20 nm, more particularly, about 5 nm to about 15 nm. The primary particles agglomerate one another and thus form the secondary particles, and an average particle diameter of the secondary particles may be, for example, in a range of about 0.1 μm to about 10 μm. The average particle diameter of the secondary particles may be, particularly, in a range of about 0.5 μm to about 5 μm, or, more particularly, about 1 μm to about 3 μm. The secondary particles exist as a powder. The sizes of the primary particles and the secondary particles may be controlled so that an effective surface effect may be manifested, and the ranges are not particularly limited thereto.

As used herein, an average particle diameter refers to an accumulative average particle diameter (D50) which corresponds to 50 volume % in an accumulative distribution curve of particle diameters based on a total volume of 100%. The average particle diameter D50 may be measured using one of various known methods in the art, for example, a particle size analyzer, or from a transmission electron microscopic (TEM) image or a scanning electron microscopic (SEM) image. Also, the D50 may be easily measured by analyzing data measured by a measuring device using a dynamic light-scattering method to count the number of particles for each particle size range and calculating an average value thereof.

The zinc oxide having a particle composition of the primary particles and the secondary particles has a high specific surface area and a low density, which lowers a melting temperature closer to a calcining temperature of the polymer resin, and thus the zinc oxide may be easily dispersed and contained in the polymer resin. A specific surface area of the zinc oxide may be about 40 m²/g or greater. A melting temperature of the zinc oxide may be about 350° C. or higher, or, for example, in a range of about 350° C. to about 450° C. In particular, the melting temperature of the zinc oxide may be in a range of about 380° C. to about 450° C. or about 400° C. to about 450° C.

The zinc oxide may be prepared according to one of various known methods in the art. For example, the zinc oxide may be prepared by forming the secondary particles by milling the primary particles, which are prepared by using a wet chemical process. In particular, for example, water or a zinc hydroxide having strong basicity may be added to a zinc halogenide aqueous solution to allow the mixture to react, and a strong basic compound that does not provide water may be added thereto to increase a temperature of the mixture so that zinc oxide primary particles having an average particle diameter in a range of about 1 nm to about 50 nm may be formed and separated. Then, the zinc oxide primary particles may undergo a milling process so that an average particle diameter of secondary particles may be maintained within a range of about 0.1 μm to about 10 μm, and thus a zinc oxide having a particle structure may be obtained.

Here, the milling process may be performed, for example, by using a zet mill, a beads mill, a high energy ball mill, a planetary mill, a stirred ball mill, or a vibration mill. In the milling process, a grinding energy should be watched not to be provided to an extensive degree as it may increase adhesive strength between particles and thus make its dispersion difficult.

Alternatively, the zinc oxide may be prepared by forming the secondary particles through a milling process using primary particles having an average particle diameter in a range of about 1 nm to about 50 nm, wherein the primary particles may be commercially available.

In one embodiment, an amount of the zinc oxide may be in a range of about 0.01 wt % to about 10 wt %, and an amount of the polymer resin may be in a range of about 90 wt % to about 99.99 wt %, based on the total amount of the zinc oxide and the polymer resin. In particular, an amount of the zinc oxide may be in a range of about 0.1 wt % to about 5 wt %, and an amount of the polymer resin may be in a range of about 95 wt % to about 99.9 wt %, based on the total amount of the zinc oxide and the polymer resin. When the amounts are within these ranges, excellent antibacterial activity may be manifested without discoloration or deterioration of physical properties.

The antibacterial fiber material may further include at least one additive selected from sunscreens, antistatic agents, softeners, sorbents, absorbents, deodorants, water repellents, antifouling agents, and flame retardants within the scope of not deteriorating the antibacterial effect. The additive may be added at an amount, for example, in a range of about 0.01 part by weight to about 5 parts by weight based on 100 parts by weight of the antibacterial fiber material.

According to another aspect of the present disclosure, antibacterial fibers include the antibacterial fiber material. The antibacterial fibers may be prepared, for example, by using a method that includes mixing a master batch containing the zinc oxide at a high concentration with a polymer resin at a predetermined ratio; and melt-spinning the mixture as will be described.

According to another aspect of the present disclosure, a master batch for manufacturing antibacterial fibers includes a polymer resin; and a zinc oxide as a powder including secondary particles that are formed of agglomerated primary particles, wherein an average particle diameter of the primary particles of the zinc oxide is in a range of about 1 nm to about 50 nm and an average particle diameter of the secondary particles is in a range of about 0.1 μm to about 10 μm.

In terms of the antibacterial fibers, the master batch is prepared to contain a high concentration of a zinc oxide so that the zinc oxide may be sufficiently dispersed in the polymer resin, and the master batch may be used in preparation of the antibacterial fibers by being mixed with a polymer base resin so that the zinc oxide is contained in the finally obtained antibacterial fibers at a desired amount.

As described above, the zinc oxide used in the master batch may have an average particle diameter of the primary particles in a range of about 1 nm to about 50 nm, or, in particular, may be in a range of about 1 nm to about 20 nm, more particularly, about 5 nm to about 15 nm. The primary particles agglomerate one another and thus form the secondary particles, and an average particle diameter of the secondary particles may be, for example, in a range of about 0.1 μm to about 10 μm, or, particularly, in a range of about 0.5 μm to about 5 μm, more particularly, about 1 μm to about 3 μm. When sizes of the primary particles and the secondary particles are within these ranges, antibacterial activity may be improved due to an effective surface effect.

A specific surface area of the zinc oxide may be about 40 m²/g or greater.

A melting temperature of the zinc oxide may be about 350° C. or higher, or, for example, in a range of about 350° C. to about 450° C. In particular, the melting temperature of the zinc oxide may be in a range of about 380° C. to about 450° C. or about 400° C. to about 450° C.

The polymer resin contained in the master batch may be any synthetic resin that may form a fiber phase, as described above, which may include at least one selected from acrylonitrile-butadiene-styrene (ABS), polypropylene (PP), polyethylene (PE), polystyrene (PS), polyvinyl acetate (PVAc), polyacrylate, polyethylene terephthalate (PET), polyvinyl chloride (PVC), polymethyl methacrylate (PMMA), ethylene-vinyl acetate copolymer (EVA), polycarbonate (PC), polyamide, and a silicone-based resin.

In the master batch, an amount of the zinc oxide may be in a range of about 1 wt % to about 50 wt %, and an amount of the polymer resin may be in a range of about 50 wt % to about 99 wt %, based on the total amount of the zinc oxide and the polymer resin. In particular, an amount of the zinc oxide may be in a range of about 5 wt % to about 30 wt %, and an amount of the polymer resin may be in a range of about 70 wt % to about 95 wt %, or, more particularly, an amount of the zinc oxide may be in a range of about 10 wt % to about 20 wt %, and an amount of the polymer resin may be in a range of about 80 wt % to about 90 wt %. When the amounts are within these ranges, a master batch with an excellent molding property without deterioration of dispersability of the zinc oxide may be prepared.

The master batch may further include at least one additive selected from dispersants, softeners, absorbents, deodorants, and water repellents within the scope of not deteriorating the antibacterial effect. The additive may be added at an amount, for example, in a range of about 0.1 part by weight to about 30 parts by weight based on 100 parts by weight of the master batch to manifest the addition effect.

The master batch may be molded into the form of a pallet to be easily mixed with a polymer base resin and disperse the zinc oxide during preparation of the antibacterial fibers.

According to another aspect of the present disclosure, a method for manufacturing antibacterial fibers includes preparing a mixture including the master batch and a polymer base resin; and melt-discharging the mixture.

The polymer base resin may be the same polymer resin that is used in the master batch. A mixing ratio of the master batch and the polymer base resin may be controlled according to a desired amount of the zinc oxide in the antibacterial fibers.

The melt-spinning of the mixture may be performed by using a double component composite spinning or a simple spinning, and the final product may be a fiber. In order to maximize the antibacterial effect, a certain degree of stretching may be induced during a spinning process to improve a flow property of the polymer resin and to allow the produced fibers to have a stretching effect.

The form of the discharged antibacterial fibers may be long fibers such as a multifilament and a monofilament or short fibers, or in any form.

The antibacterial fibers may include antistatic agents, softeners, absorbents, deodorants, water repellents, antifouling agents, flame retardants, or anti-mite agents by being processed within the scope that does not deteriorate an antibacterial performance. Also, the antibacterial fibers may undergo a water-repellent process.

The antibacterial fibers thus obtained may include the homogeneously distributed zinc oxide and thus may exhibit excellent antibacterial activity.

### Mode of the Invention Concept

Hereinafter, one or more embodiments of the present disclosure will be described in detail with reference to the following examples. However, these examples are not intended to limit the scope of the present disclosure.

### Example 1

Nanosized zinc oxide powder particles (zinc oxide having a primary particle diameter in a range of about 5 nm to about 15 nm and a specific surface area of about 47 m²/g, available from SH Energy & Chemical Co., Ltd.), as an antibacterial agent, were processed in an oscillator to maintain a secondary particle diameter to about 1.7 μm, and the resultant was processed to a high-pressure extruder (an apparatus possessed by Korea Institute of Industrial Technology) with polypropylene (MI-800 product) at a weight ratio of 1:19 to prepare a master batch.

The master batch was mixed with polypropylene (MI-800 product) at a weight ratio of 1:4, melted at a temperature of 180° C. and discharged by using Melt Brown non-woven fiber preparation equipment possessed by Korea Institute of Industrial Technology to prepare antibacterial fibers.

### Comparative Example 1

In order to manufacture fibers not including zinc oxide, polypropylene (MI-800 product) was melted at a temperature of 180° C. and discharged by using the Melt Brown non-woven fabric fiber preparation equipment possessed by Korea Institute of Industrial Technology to prepare the fibers.

### Measurement of Antibacterial Degree

Antibacterial degrees of a polypropylene non-woven fabric (#1) prepared by using the fiber according to Comparative Example 1 and a polypropylene non-woven fabric (#2) prepared by using the antibacterial fibers according to Example 1 were evaluated according to the KS J 4206 method. Test strains were Staphylococcus aureus ATCC 6538, Escherichia coli ATCC 25922, and Pseudomonas aeruginosa ATCC 27853 that were used.
Test condition: a test bacteria solution was shake-cultured at 37±1° C. for 24 hours, and the number of bacteria cells was measured (at 120 shaking cycles/minute)
Test sample weight: 2.0 g
A neutralization solution: a phosphate buffer solution (pH 7.0±0.2)
A decrease rate (%): [(Mb−Mc)/Mb]×100
An increase rate (F): Mb/Ma (31.6 times or greater)
Ma: the initial number of cells in a control sample (an average value)
Mb: the number of cells in a control sample after 24 hours of culturing (an average value)
Mc: the number of cells in a test sample after 24 hours of culturing (an average value)

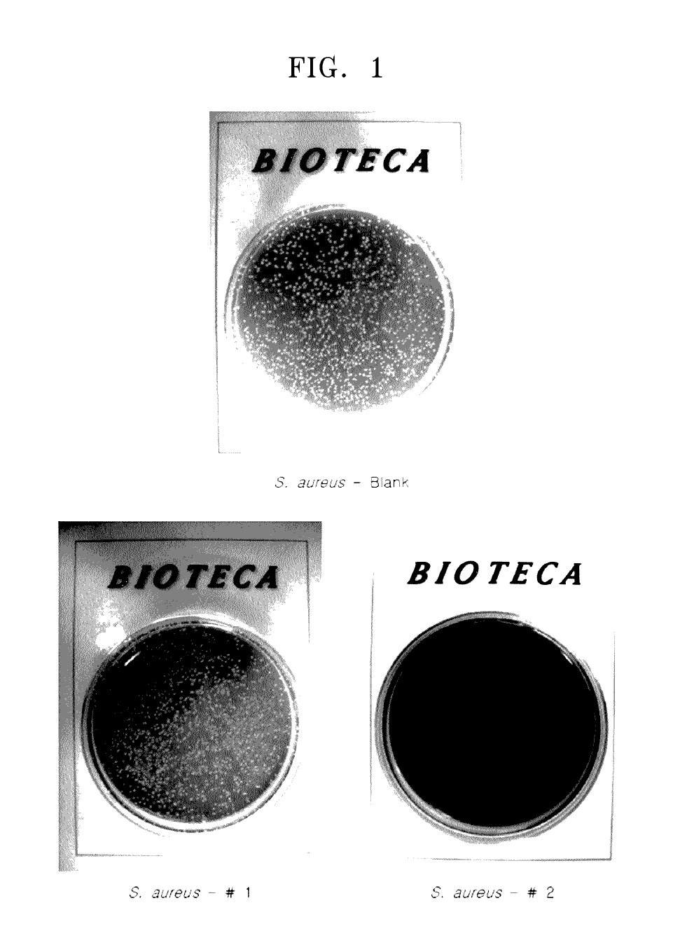

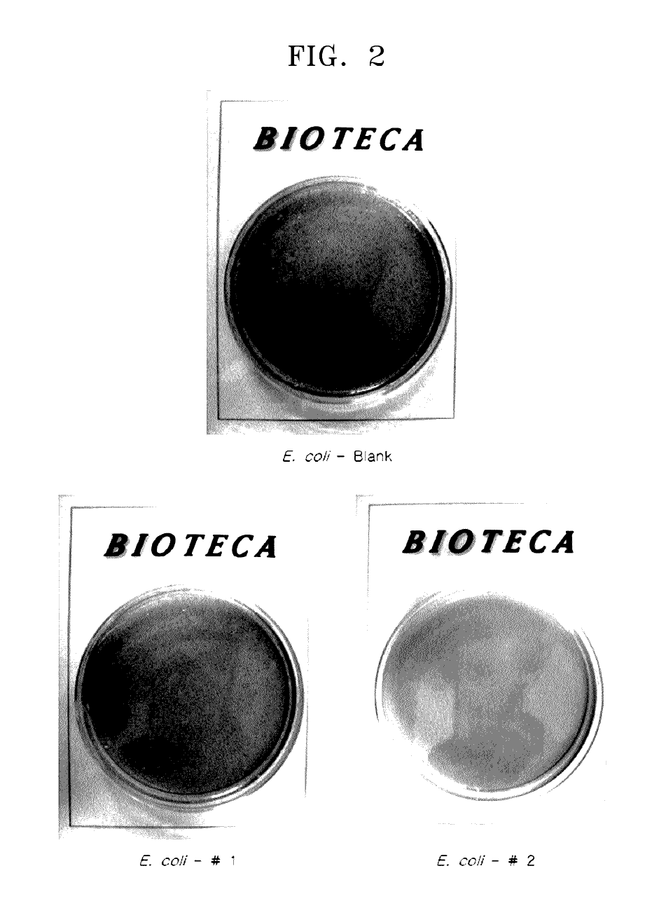

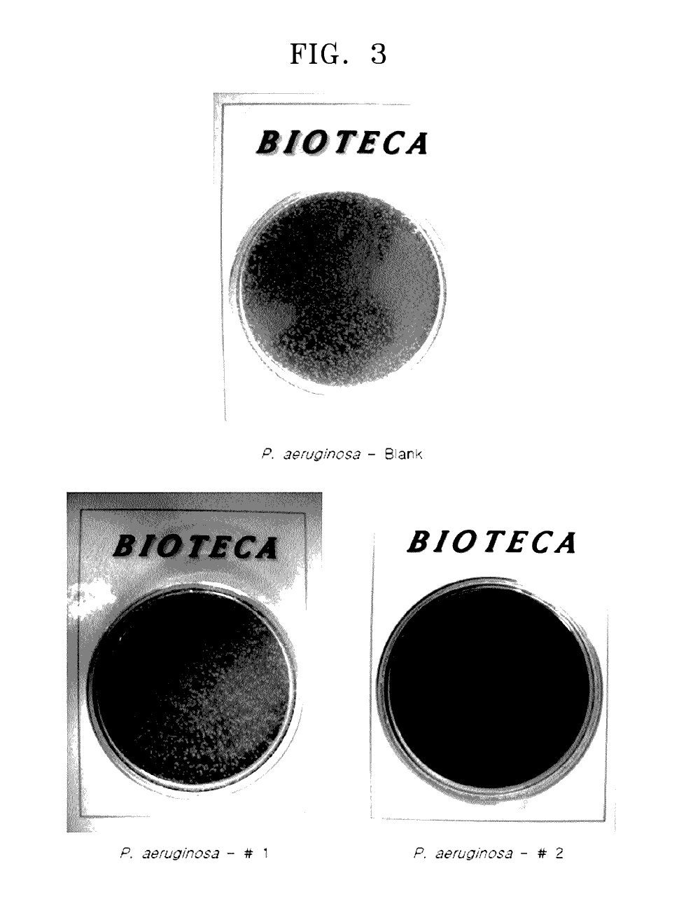

The results of measuring an antibacterial degree (a cell reduction ratio, %) of each test strain are shown in Tables 1 to 3 and FIGS. 1 to 3.

TABLE 1

| | Strain 1: Staphylococcus aureus ATCC 6538 | |
|---|---|---|
| | Comparative Example 1 (#1) | Example 1 (#2) |
| Concentration of | 1.3 × 10⁵ | |
| inoculated cells | | |
| Increase rate (F) | 51 TIMES | |
| Ma | 1.3 × 10⁵ | |
| Mb | 6.6 × 10⁷ | |
| Mc | 4.9 × 10⁶ | <10 |
| Decrease rate (%) | 25.8 | 99.9 |

(*CFU = Colony Forming Unit, < = less than)

TABLE 2

| | Strain 2: Escherichia coli ATCC 25922 | |
|---|---|---|
| | Comparative Example 1 (#1) | Example 1 (#2) |
| Concentration of | 1.2 × 10⁵ | |
| inoculated cells | | |
| Increase rate (F) | 49 TIMES | |
| Ma | 1.2 × 10⁵ | |
| Mb | 5.9 × 10⁶ | |
| Mc | 4.3 × 10⁶ | <10 |
| Decrease rate (%) | 27.9 | 99.9 |

(*CFU = Colony Forming Unit, < = less than)

TABLE 3

| | Strain 3: Pseudomonas aeruginosa | |
|---|---|---|
| | ATCC 27853 | |
| | Comparative Example 1 (#1) | Example 1 (#2) |
| Concentration of | 1.5 × 10⁵ | |
| inoculated cells | | |
| Increase rate (F) | 48 TIMES | |
| Ma | 1.5 × 10⁵ | |
| Mb | 7.2 × 10⁶ | |
| Mc | 4.5 × 10⁶ | <10 |
| Decrease rate (%) | 37.8 | 99.9 |

(*CFU = Colony Forming Unit, < = less than)

As shown in Tables 1 to 3 and FIGS. 1 to 3, it may be known that the antibacterial fibers prepared in Example 1 exhibited 99.9% of antibacterial activity, which is the commercially perfect level.

While the inventive concept has been particularly shown and described with reference to exemplary embodiments thereof, it will be understood that various changes in form and details may be made therein without departing from the spirit and scope of the following claims.

1. An antibacterial fiber material comprising:
a polymer resin; and
a zinc oxide in a form of a powder comprising secondary particles where primary particles are agglomerated to form the secondary particles,
wherein an average particle diameter of the primary particles of the zinc oxide is in a range of about 1 nm to about 50 nm and an average particle diameter of the secondary particles is in a range of about 0.1 μm to about 10 μm.

2. The antibacterial fiber material of claim 1, wherein a specific surface area of the zinc oxide is about 40 m²/g or greater.

3. The antibacterial fiber material of claim 1, wherein a melting temperature of the zinc oxide is about 350° C. or higher.

4. The antibacterial fiber material of claim 3, wherein the melting temperature of the zinc oxide is in a range of about 350° C. to about 450° C.

5. The antibacterial fiber material of claim 1, wherein the polymer resin comprises at least one selected from acrylonitrile-butadiene-styrene (ABS), polypropylene (PP), polyethylene (PE), polystyrene (PS), polyvinyl acetate (PVAc), polyacrylate, polyethylene terephthalate (PET), polyvinyl chloride (PVC), polymethyl methacrylate (PMMA), ethylene-vinyl acetate copolymer (EVA), polycarbonate (PC), polyamide, and a silicone-based resin.

6. The antibacterial fiber material of claim 1, wherein an amount of the zinc oxide is in a range of about 0.01 wt % to about 10 wt %, and an amount of the polymer resin is in a range of about 90 wt % to about 99.99 wt %, based on the total amount of the zinc oxide and the polymer resin.

7. The antibacterial fiber material of claim 1, further comprising at least one additive selected from sunscreens, antistatic agents, softeners, sorbents, absorbents, deodorants, water repellents, antifouling agents, and flame retardants.

8. The antibacterial fiber material of claim 7, wherein the least one additive is comprised at an amount in a range of about 0.01 part by weight to about 5 parts by weight based on 100 parts by weight of the antibacterial fiber material.

9. Antibacterial fibers comprising the antibacterial fiber material according to claim 1.

10. A master batch for manufacturing antibacterial fibers, wherein the antibacterial fibers comprise:
a polymer resin; and
a zinc oxide as a powder comprising secondary particles that are formed of agglomerated primary particles,
wherein an average particle diameter of the agglomerated primary particles of the zinc oxide is in a range of about 1 nm to about 50 nm and an average particle diameter of the secondary particles is in a range of about 0.1 μm to about 10 μm.

11. The master batch of claim 10, wherein a specific surface area of the zinc oxide is about 40 m²/g or greater.

12. The master batch of claim 10, wherein a melting temperature of the zinc oxide is about 350° C. or higher.

13. The master batch of claim 12, wherein the melting temperature of the zinc oxide is in a range of about 350° C. to about 450° C.

14. The master batch of claim 10, wherein the polymer resin comprises at least one selected from acrylonitrile-butadiene-styrene (ABS), polypropylene (PP), polyethylene (PE), polystyrene (PS), polyvinyl acetate (PVAc), polyacrylate, polyethylene terephthalate (PET), polyvinyl chloride (PVC), polymethyl methacrylate (PMMA), ethylene-vinyl acetate copolymer (EVA), polycarbonate (PC), polyamide, and a silicone-based resin.

15. The master batch of claim 10, wherein an amount of the zinc oxide is in a range of about 1 wt % to about 50 wt %, and an amount of the polymer resin is in a range of about 50 wt % to about 99 wt %, based on the total amount of the zinc oxide and the polymer resin.

16. The master batch of claim 10 further comprising at least one additive selected from dispersants, softeners, absorbents, deodorants, and water repellents.

17. The master batch of claim 16, wherein the additive is comprised at an amount in a range of about 0.1 part by weight to about 30 parts by weight based on 100 parts by weight of the master batch.

18. A method for manufacturing antibacterial fibers, the method comprising:
preparing a mixture that comprises the master batch according to claim 10 and a polymer base resin; and
discharging the mixture.

19. The method of claim 18, wherein the polymer base resin is of a same type as a polymer resin used in the master batch.
